(19) United States
(12) Patent Application Publication
(10) Pub. No.: US 2002/0043622 A1
(43) Pub. Date: Apr. 18, 2002

(54) Arrangement for studying microscopic preparations with a scanning microscope

(76) Inventors: Holger Birk, Meckesheim (DE); Rafael Storz, Bammental (DE); Johann Engelhardt, Schoenborn (DE)

Correspondence Address: Glenn Law, FOLEY & LARDNER, Washington Harbour, 3000 K Street, N.W., Suite 500, Washington, DC, 20007-5109, US

(21) Appl. No.: 09/881,048

(22) Filed: Jun. 15, 2001

(30) Foreign Application Priority Data
Jun. 17, 2000 (DE) DE 100 30 013.8
Mar. 29, 2001 (DE) DE 101 15 487.9

(51) Int. Cl. G01N 23/00

(52) U.S. Cl. 250/306

(57) ABSTRACT

The arrangement for studying microscopic preparations with a scanning microscope consists of a laser (1) and an objective (12), which focuses the light produced by the laser (1) onto a sample (13) to be studied, an optical waveguide element (3), which transports the light produced by the laser (1), being provided between the laser (1) and the objective (12). The optical waveguide element is constructed from a plurality of micro-optical structure elements which have at least two different optical densities. It is particularly advantageous if the optical waveguide element (3) consists of photonic band gap material and is configured as an optical fiber.

### CROSS REFERENCE TO RELATED APPLICATIONS

This invention claims priority of the German patent applications 100 30 013.8 and 101 15 487.9 which are incorporated by reference herein.

### FIELD OF THE INVENTION

The invention relates to an arrangement for studying microscopic preparations with a scanning microscope. In particular, the invention relates to an arrangement for studying microscopic preparations with a scanning microscope, which comprises a laser and an optical means, which focuses the light produced by the laser onto a sample to be studied. The scanning microscope may also be configured as a confocal microscope.

### BACKGROUND OF THE INVENTION

In scanning microscopy, a sample is scanned with a light beam. Lasers are often used as the light source for this. EP 0 495 930: “Konfokales Mikroskopsystem für Mehrfarbenfluoreszenz” [Confocal microscope system for multicolour fluorescence], for example, discloses an arrangement having a single laser which emits several laser lines. Mixed gas lasers, especially ArKr lasers, are mainly used for this at present.

It is also conceivable to use diode lasers and solid-state lasers. U.S. Pat. No. 5,161,053, with the title “Confocal Microscope”, discloses a confocal microscope in which light from an external light source is transported to the beam path of the microscope with the aid of a glass fibre, and the end of the glass fibre acts as a point light source so that a mechanical aperture is unnecessary.

The use of ultraviolet light in scanning microscopy is known, for example, from European Patent EP 0 592 089 “Scanning confocal microscope providing a continuous display”. Unfortunately, injecting the UV light with the aid of the optical fibre usually causes irreversible damage to the optical fibre after a few hours. Inter alia, colour centres are formed which greatly reduce the transmissivity of the optical fibre.

A device for extending the life of the optical fibre is disclosed in German Patent DE 44 46 185 “Device for feeding a UV laser into a confocal scanning microscope”. There, a beam stopper is used which only releases the UV light beam when the UV light beam is actually needed for the imaging. This device reduces the problem of damage to the optical fibre, but does not fundamentally solve it.

### SUMMARY OF THE INVENTION

It is an object of the invention to provide a scanning microscope with an optical waveguide which efficiently transports light from a light source to the beam path of the scanning microscope without damage of the optical waveguide or its structure.

The object is achieved by a scanning microscope comprising: a laser, an objective, which focuses the light produced by the laser onto a sample, an optical waveguide element arranged between the laser and the objective, whereby the optical waveguide element transports the light produced by the laser and whereby the optical waveguide element is constructed from a plurality of micro-optical structure elements which have at least two different optical densities.

The optical waveguide element preferably has micro-optical structure elements in the form of cannulas, webs, honeycombs, tubes or cavities. Through such an optically non-linear construction, UV light, in particular, is guided without damaging the optical waveguide element or its structure.

Good handlability is provided by designing the optical waveguide element as an optical fibre.

In a preferred configuration, the optical waveguide element contains a first and a second region, the first region having a homogeneous structure, and a microscopic structure comprising micro-optical structure elements being formed in the second region. This configuration is particularly advantageous if the first region encloses the second region.

The optical waveguide element in the form of a “photonic band gap material” has the advantage that, through the optically non-linear construction of the fibre, UV light is guided without damaging the fibre or its structure. “Photonic band gap material” is microstructured transparent material. Usually by combining various dielectrics, it is possible to give the resulting crystal a band structure for photons which is reminiscent of the electronic band structure of semiconductors.

The technique has recently been implemented with optical fibres as well. The fibres are produced by pulling structuredly arranged glass tubes or glass blocks, so as to create a structure which has glass or plastic material and cavities adjacent to one another. The fibres are based on a particular structure: small cannulas which have a spacing of about 2-3 μm and a diameter of approximately 1-2 μm and are usually filled with air, are left free in the fibre direction, cannula diameters of 1.9 μm being particularly suitable. There are usually no cannulas in the middle of the fibre. These types of fibres are also known as “photon crystal fibres”, “holey fibres” or “microstructured fibres”. Also known are configurations as a so-called “hollow fibre”, in which there is a generally air-filled tube in the middle of the fibre, around which cannulas are arranged. Fibres of this type are particularly intended for transporting UV light, since the light is guided not in the optically dense fibre material but in the cavities.

For use in microscopy, it is important to implement means for light-power stabilization. Therefore, such an optical waveguide element may advantageously be combined with acousto- or electro-optical tunable filters (AOTFs), with acousto- or electro-optical deflectors (AODs), or acousto- or electro-optical beam splitters (AOBSs). These can be employed both for wavelength selection and for stopping out the detection light. This technology is described in the German patent application DE 199 06 757 Al:“Optical arrangement with spectrally selective element for use in the beam path of a light source suitable for stimulation of fluorescence, pref. a confocal laser-scanning microscope”.

Especially in confocal microscopy, the exit end of the optical fibre can be used as a point light source, so that it is unnecessary to use an excitation aperture.

In other embodiments, devices to compensate for light-power fluctuations are provided. For example, it is possible to incorporate a control loop for light-power stabilization, which parasitically measures the light power in the beam path of the microscope and. for example by varying the pump-light power or with the aid of an acousto- or electro-optical element, keeps the sample illumination light power constant. To that end, LCD attenuators could also be used.

Another advantage of the invention is to configure the optical waveguide element in such a way that both UV light and light with other wavelengths can be transported to the scanning microscope substantially without losses and damage, especially if the illuminating device is already correspondingly configured so that it provides a plurality of spectral ranges for the illumination. The laser, which represents the illuminating device for a scanning microscope, has an optical component fastened to the light exit opening. The optical component consists of photonic band gap material. The photonic band gap material may also be configured as an optical fibre.

### BRIEF DESCRIPTION OF THE DRAWINGS

The subject-matter of the invention is schematically represented in the drawing and will be described below with the aid of the figures, in which:

FIG. 1 shows an arrangement according to the invention with a confocal microscope,

FIG. 2 shows an arrangement with a control loop for light-power stabilization,

FIG. 3 shows a schematic representation of an optical waveguide element,

FIG. 4 shows another schematic representation of an optical waveguide element, and

FIG. 5 shows another schematic representation of an optical waveguide element.

### DETAILED DESCRIPTION OF THE INVENTION

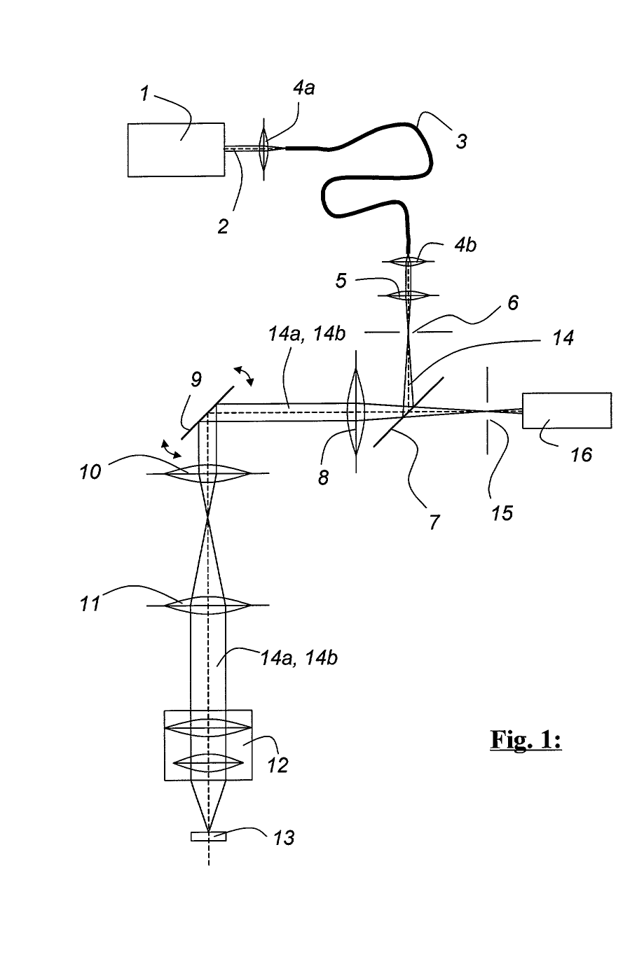

FIG. 1 shows a confocal microscope, which uses an optical waveguide element 3, designed as an optical fibre for transporting the light produced by a laser 1, which is designed as a mixed gas laser. The laser 1 defines a laser beam 2, which is guided through the optical waveguide element 3. The optical waveguide element 3 is embodied as an optical fibre and consists of photonic band gap material. An input lens 4a is arranged in front of the optical waveguide element 3, and an output lens 4b is arranged after it. An illumination light beam 14 emerges from the optical waveguide element 3, is projected by a first lens 5 onto an illumination pinhole 6 and then strikes a beam splitter 7. From the beam splitter 7, the illumination light beam 14 travels to a second lens 8, which produces a parallel light beam 14a that strikes a scanning mirror 9. A plurality of lenses 10 and 11, which shape the light beam 14a, are connected downstream of the scanning mirror 9. The light beam 14a travels to an objective 12, by which it is focussed onto a sample 13. The light reflected or emitted by the sample defines an observation beam path 14b. The light of the observation beam path 14b passes once more through the second lens 8 and is projected onto a detection pinhole 15, which is located in front of a detector 16. Through the optical waveguide element 3, the light which is needed for studying the sample 13 and also contains UV components can be transported without damage.

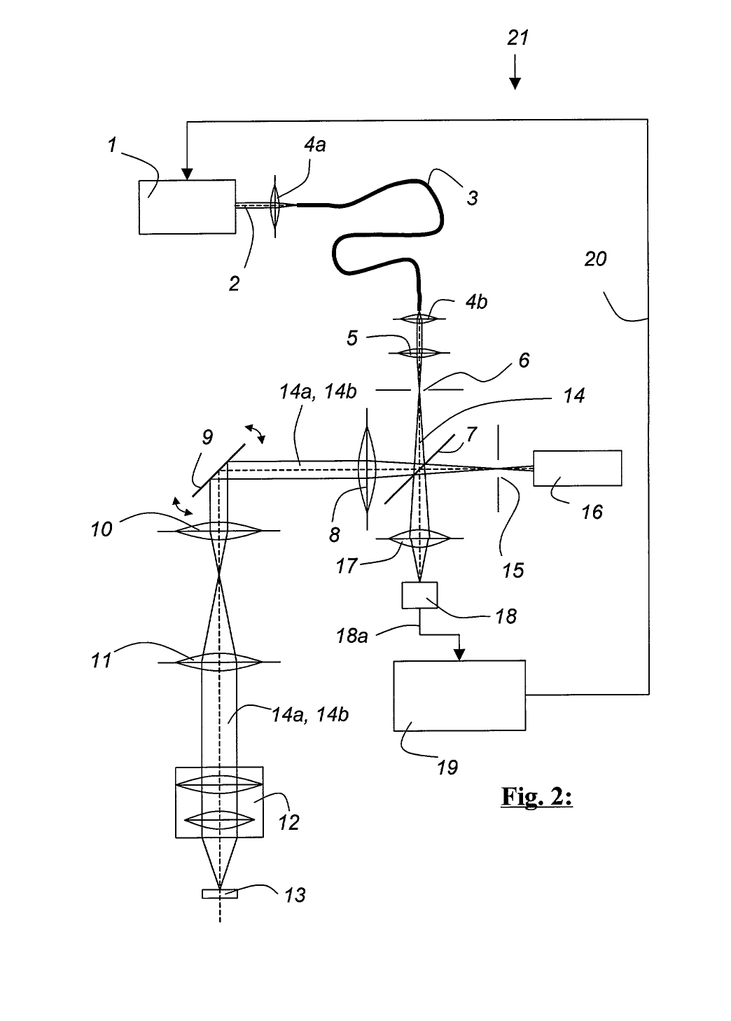

The embodiment represented in FIG. 2 corresponds largely to the embodiment described in FIG. 1. A control loop 21 for light-power stabilization is also provided. The minor component of the illumination light beam 14 passing through the beam splitter 7 is focused, with the aid of the lens 17, onto a photodiode 18 which produces an electrical signal proportional to the power of the incident light. This signal is forwarded via the line 18a to the control unit 19, which calculates a control signal that is fed via the line 20 to the remote-control input of the laser 1. The control unit is configured in such a way that the light power of the illumination light beam 14 is substantially constant after emerging from the optical waveguide element 3, so that it is also possible to compensate for transmission fluctuations.

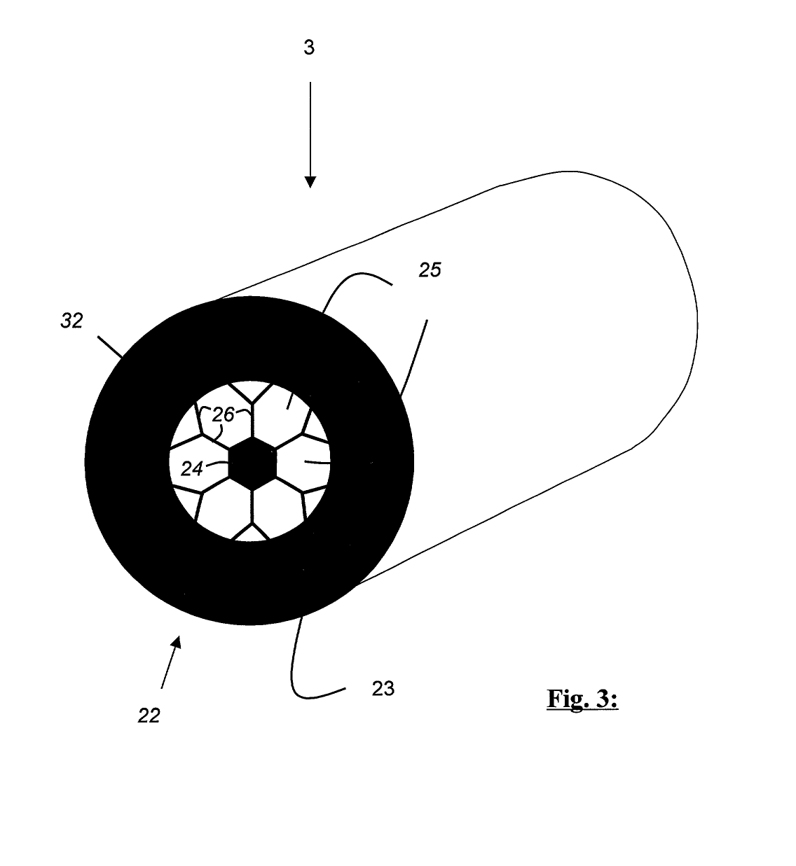

FIG. 3 shows an embodiment of the optical waveguide element 3, which has a special honeycombed microstructure 22. The honeycombed structure that is shown is particularly suitable for the transport of both UV and visible light. The diameter of the glass inner cannula 24 is approximately 1.9 μm. The inner cannula 24 is surrounded by glass webs 26. The glass webs 26 form honeycombed cavities 25. These micro-optical structure elements together form a second region 32, which is enclosed by a first region 23 that is designed as a glass cladding.

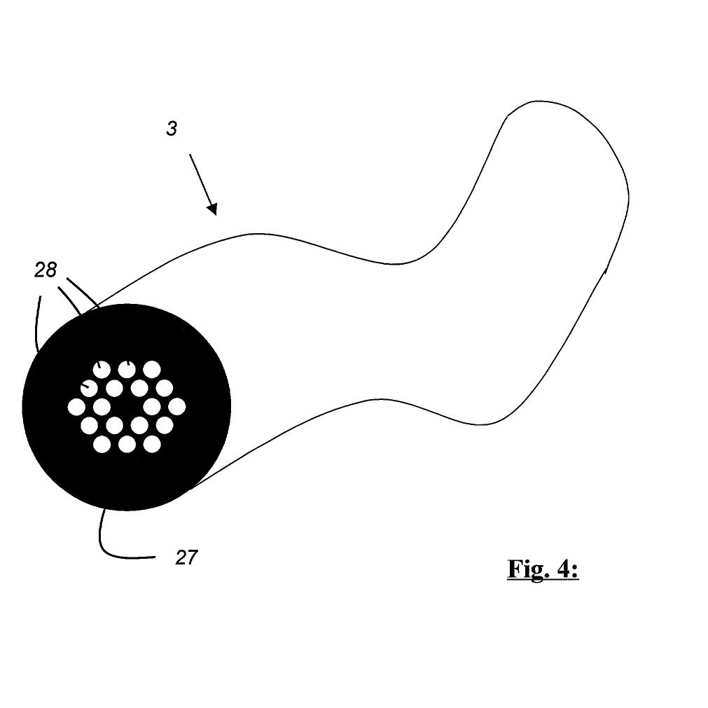

FIG. 4 shows an embodiment of the optical waveguide element 3, which is configured as a flexible fibre and consists of a glass body 27 that contains a plurality of hollow cannulas 28. There is no hollow cannula at the centre in this configuration.

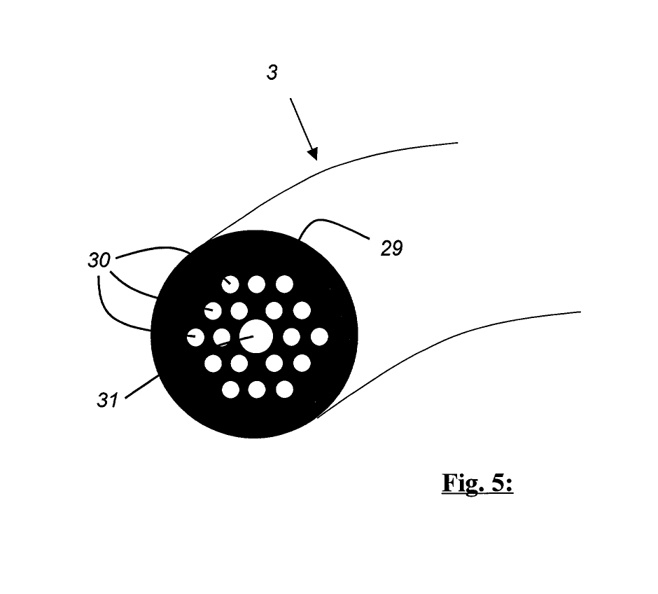

FIG. 5 shows another embodiment of the optical waveguide element that consists of a plastic or glass body 29, in which there are hollow cannulas 30 having an internal diameter of typically 1.9 μm. In the centre of the optical waveguide element 3, there is a hollow cannula 31 that has an internal diameter of typically 3 μm.

The invention has been described with reference to a particular embodiment. It is, however, obvious that modifications and amendments may be made without thereby departing from the scope of protection of the following claims.

Parts List

1 laser

2 laser beam

3 optical waveguide element

4a input lens

4b output lens

5 lens

6 illumination pinhole

7 beam splitter

8 lens

9 scanning mirror

10 lens

11 lens

12 objective

13 sample

14 illumination light beam

14a light beam

14b observation beam path

15 detection pinhole

16 detector

17 lens

18 photodiode

18a line

19 control unit

20 line

21 control loop

22 microstructure

23 first region

24 inner cannula

25 cavities

26 glass webs

27 glass body

28 cannulas

29 plastic body

30 hollow cannulas

31 hollow cannula

32 second region

What is claimed is:

1. A scanning microscope comprising: a laser, an objective, which focuses the light produced by the laser onto a sample, an optical waveguide element arranged between the laser and the objective, whereby the optical waveguide element transports the light produced by the laser and whereby the optical waveguide element is constructed from a plurality of micro-optical structure elements which have at least two different optical densities.

2. Scanning microscope according to claim 1, wherein the microstructured optical element comprises a first region having a homogeneous structure and a second region formed by micro-optical structure elements.

3. Scanning microscope according to claim 1, wherein the first region encloses the second region.

4. Scanning microscope according to claim 1, wherein the microstructured optical element consists essentially of adjacent glass, plastic material, cavities, cannulas, webs, honeycombs or tubes.

5. Scanning microscope according to claim 1, wherein the microstructured optical element consists of photonic band gap material.

6. Scanning microscope according to claim 1, wherein the microstructured optical element is configured as an optical fibre.

7. Scanning microscope according to claim 1, wherein the laser emits UV light.

8. Scanning microscope according to claim 1, further comprising means for light-power stabilization.

9. Scanning microscope according to claim 8, wherein the means for light-power stabilization contain a control loop.

10. A scanning confocal microscope comprising: a laser, an objective, which focuses the light produced by the laser onto a sample, an optical waveguide element arranged between the laser and the objective, whereby the optical waveguide element transports the light produced by the laser and whereby the optical waveguide element is constructed from a plurality of micro-optical structure elements which have at least two different optical densities.

11. Scanning confocal microscope according to claim 10, wherein the microstructured optical element comprises a first region having a homogeneous structure and a second region formed by micro-optical structure elements.

12. Scanning confocal microscope according to claim 10, wherein the first region encloses the second region.

13. Scanning confocal microscope according to claim 10, wherein the microstructured optical element consists essentially of adjacent glass, plastic material, cavities, cannulas, webs, honeycombs or tubes.

14. Scanning confocal microscope according to claim 10, wherein the microstructured optical element consists of photonic band gap material.

15. Scanning confocal microscope according to claim 10, wherein the microstructured optical element is configured as an optical fibre.

16. Scanning confocal microscope according to claim 15, wherein the exit end of the optical fibre is used as an illumination aperture.

17. Scanning confocal microscope according to claim 10, wherein the laser emits UV light.

18. Scanning confocal microscope according to claim 10, further comprising means for light-power stabilization.

19. Scanning confocal microscope according to claim 18, wherein the means for light-power stabilization contain a control loop.
